(19) United States
(12) Patent Application Publication
(10) Pub. No.: US 2014/0061373 A1
(43) Pub. Date: Mar. 6, 2014

(54) CONTROLS FOR AIRCRAFT E-TAXI

(71) Applicant: Michael Krenz, Roscoe, IL (US)

(72) Inventor: Michael Krenz, Roscoe, IL (US)

(21) Appl. No.: 13/600,343

(22) Filed: Aug. 31, 2012

(51) Int. Cl. B64C 25/50

(52) U.S. Cl. 244/50

(57) ABSTRACT

An e-Taxi system has a landing gear wheel and a motor for the landing gear wheel. A main controller communicates with an aircraft tiller, which is operable to send signals to the main control relative to desired steering through the landing gear wheel. A disable/enable switch selectively enables or disables the e-Taxi drive of the landing gear wheel and a reverse/forward switch is provided comparable to demand a desired direction of drive of the landing gear wheel.

### BACKGROUND OF THE INVENTION

This application relates to a control scheme for providing control signals to electric drive motors for e-Taxi.

Historically, aircraft are moved away from a gate in an airport, to begin taxing toward a runway, by a tug.

More recently, e-Taxi systems have been proposed wherein the aircraft utilizes its landing gear wheels, in combination with drive motors.

However, the known art has not provided practical control schemes for e-Taxi systems

### SUMMARY OF THE INVENTION

An e-Taxi system has a landing gear wheel and a motor for the landing gear wheel. A main controller communicates with an aircraft tiller, which is operable to send signals to the main control relative to desired steering through the landing gear wheel. A disable/enable switch selectively enables or disables the e-Taxi drive of the landing gear wheel and a reverse/forward switch is provided to demand a desired direction of drive of the landing gear wheel.

These and other features of this application will be best understood from the following specification and drawings, the following of which is a brief description.

### BRIEF DESCRIPTION OF THE DRAWINGS

FIG. 1 schematically shows a control assembly for an aircraft e-Taxi system.

FIG. 2 shows an alternative input design.

### DETAILED DESCRIPTION

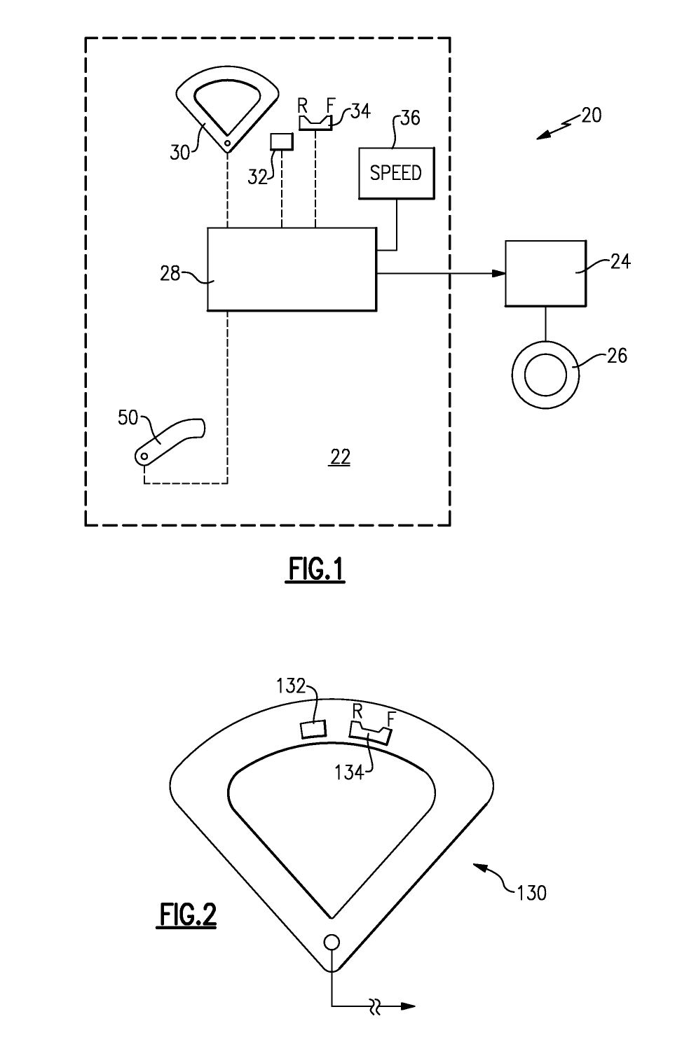

FIG. 1 schematically shows an aircraft 20 incorporating drive motors 24 for selectively driving a landing gear wheel 26. A cockpit 22 includes a main controller 28 which sends signals to the motors 24, which will act to drive the motors 24 in forward, or reverse, and to steer the wheel 26.

A tiller 30 provides control signals to the controller 28. The tiller 30 typically sits to the left-hand side of an aircraft pilot, and serves to allow turning or steering of the aircraft 20 through the landing gear wheel 26.

An e-Taxi control is incorporated in controller 28 and includes a disable/enable switch 32. Typically, when taxiing is not occurring, the switch 32 will disable the e-Taxi system such that drive does not occur inadvertently. A rocker switch 34 has a reverse and forward position. The reverse/forward switch is preferably biased to a central position away from either the forward or reverse positions, and returns to that central position when released. A display 36 will display the direction that the aircraft 20 will be driven in.

Now, when the pilot wishes to reverse drive the aircraft 20 away from an airport gate, the disable/enable switch 32 is moved to the enable position, and the rocker switch 34 has its rear direction actuated. In one embodiment, the amount of time the switch is held in the rear position will increase the speed that the aircraft 20 will be driven. That is, a demanded speed may increase as the time the switch is held in the position increases. A demanded speed, and an actual speed may also be displayed on the display 36.

In another embodiment, a demanded speed is changed by repeated actuation of the switches in the forward or rear directions, rather than the time it is held down. A speed decrease can be commanded by actuation of the rocker switch 34 in the opposed direction.

The pilot is able to actuate the aircraft 20 and being to reverse it away from the gate. At some point, the rearward travel has been complete, and the brakes 50 may be actuated. In an embodiment, when the brakes are actuated, the previous speed and direction demanded from the switch 34 is stopped, and a new direction and speed must be entered, and deleted from the control 28. In some embodiments, direction of travel cannot be changed until the brakes 50 are actuated, or the aircraft is brought to a stop with zero speed commanded.

Typically, the pilot may then choose to move the rocker switch 34 to the forward position, and hold it in that position until the desired speed is reached, and displayed on display 36.

FIG. 2 shows an alternative embodiment 130, wherein the disable/enable switch 132, and the rocker switch 134 are actually physically incorporated into the tiller. This may prove to be the most convenient location for a pilot.

Although an embodiment of this invention has been disclosed, a worker of ordinary skill in this art would recognize that certain modifications would come within the scope of this invention. For that reason, the following claims should be studied to determine the true scope and content of this invention.

1. An e-Taxi system comprising:
a landing gear wheel to be associated with an aircraft, and a motor for said landing gear wheel;
a controller communicating with an aircraft tiller, said aircraft tiller being operable to send signals to said main controller to demand desired steering through the landing gear wheel; and
a disable/enable switch for selectively enabling and disabling e-Taxi drive of the landing gear wheel, and a reverse/forward switch, said reverse/forward switch being operable to demand a desired direction of drive of said landing gear wheel.

2. The system as set forth in claim 1, wherein said reverse/forward switch is a rocker switch that can be rocked to a reverse or a forward position.

3. The system as set forth in claim 2, wherein said forward/reverse switch also allows a demanded speed to be entered.

4. The system as set forth in claim 3, wherein said rocker switch may be held in said reverse or forward position for a period of time to demand the speed, and said demanded speed is sent to said control to be achieved by said landing gear wheel, with said demanded speed increasing as the amount of time said rocker switch is held in the reverse or forward position increases.

5. The system as set forth in claim 3, wherein the forward/reverse switch can be repeatedly actuated to change the demanded speed.

6. The system as set forth in claim 3, wherein said demanded speed is displayed on a display to be mounted in an aircraft cockpit.

7. The system as set forth in claim 6, wherein an actual speed is also displayed.

8. The system as set forth in claim 3, wherein when a brake associated with said landing gear wheel is actuated, said demanded speed and said demanded direction are stopped and a new speed must be entered.

9. The system as set forth in claim 1, wherein said forward/reverse switch also allows a demanded speed to be entered.

10. The system as set forth in claim 9, wherein said rocker switch may be held in said reverse or forward position for a period of time to demand the speed, and said demanded speed is sent to said control to be achieved by said landing gear wheel, with said demanded speed increasing as the amount of time said rocker switch is held in the reverse or forward position increases.

11. The system as set forth in claim 9, wherein the forward/reverse switch can be repeatedly actuated to change the demanded speed.

12. The system as set forth in claim 1, wherein said demanded speed is displayed on a display to be mounted in an aircraft cockpit.

13. The system as set forth in claim 12, wherein an actual speed is also displayed.

14. The system as set forth in claim 1, wherein said disable/enable switch and said reverse/forward switch are incorporated into said tiller.
